(19) United States
(12) Patent Application Publication
(10) Pub. No.: US 2026/0141437 A1
(43) Pub. Date: May 21, 2026

(54) Automatic Wine Recommendation Using a Customized Machine Learning Model

(71) Applicant: PalmSom, LLC, Uniontown, PA (US)

(72) Inventor: Lindsey FERN, Uniontown, PA (US)

(21) Appl. No.: 19/393,966

(22) Filed: Nov. 19, 2025

Related U.S. Application Data
(60) Provisional application No. 63/722,674, filed on Nov. 20, 2024.

(51) Int. Cl. G06Q 30/0601

(52) U.S. Cl. CPC G06Q 30/06311; G06Q 30/0643

(57) ABSTRACT

Aspects of the present disclosure relate to generating automatic wine recommendations using artificial intelligence (AI). A wine recommendation system can customize a machine learning model using exemplary wine selections made by or for particular users having particular characteristics (e.g., demographic data, preferences, historical wine selections, etc.), wine definitions (for varietals generally and/or for specific wines made by specific producers for specific vintages), and role(s) the machine learning model should assume in selecting a wine. Based on a user profile and available wines indicated on a wine list, the wine recommendation system can apply the customized machine learning model to select a wine for the user, which can further be based on contextual factors, such as a food being consumed, the user's environment (e.g., a party, a restaurant, outdoors, weather, etc.), and/or the like.

### CROSS-REFERENCE TO RELATED APPLICATIONS

This application claims priority to U.S. Patent Application No. 62/722,674, titled “SYSTEMS AND METHODS FOR AUTOMATIC WINE RECOMMENDATION,” which is herein incorporated by reference in its entirety.

### TECHNICAL FIELD

The present disclosure is directed to generating automatic wine recommendations using artificial intelligence (AI).

### BACKGROUND

The world of wine is vast and complex, encompassing countless varietals, regions, producers, and vintages, each with its own unique characteristics and terminology. For many consumers, from novices to even seasoned enthusiasts, navigating this complexity can be an overwhelming experience. Choosing the right wine for a particular occasion, meal, or personal preference often requires a significant amount of knowledge and experience that the average person does not possess.

Traditionally, individuals seeking a wine recommendation, particularly in a restaurant setting, rely on the expertise of a sommelier. A sommelier is a trained and knowledgeable wine professional who provides expert service, typically in fine dining establishments. The process involves a personal consultation where the diner might describe their taste preferences (e.g., “I like dry, full-bodied reds”), their intended meal pairing, and their desired price range. The sommelier then uses their deep knowledge of wine and the specific inventory of the restaurant's cellar to recommend a suitable bottle from the wine list. This highly personalized, context-aware service represents the gold standard for wine selection, as it is tailored to the individual's palate and the specific options available at that moment.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for automatically recommending wine to a user.

FIG. 5 a block diagram illustrating a system of inputs to and outputs from a customized machine learning model for automatically recommending wine to a user.

FIG. 6 is a flow diagram illustrating a process used in some implementations for customizing a trained model to perform one or more steps of the processes described herein.

FIG. 7 is a block diagram illustrating an overview of a machine learning system that can be applied and customized to perform one or more steps of the processes described herein according to some implementations of the present technology.

FIG. 8A is a conceptual diagram illustrating an exemplary field-of-view, of a camera of a mobile device, including a wine list that can be input into a customized machine learning model to automatically recommend wine to a user.

FIG. 8B is a conceptual diagram illustrating an example field-of-view, of a camera of a mobile device, including an image of food that can be captured and input to a customized machine learning model to automatically recommend wine to a user.

FIG. 8C is a conceptual diagram illustrating an example field-of-view, of a user, including a user interface presented on a mobile device with recommended wines predicted by a customized machine learning model.

The techniques introduced here may be better understood by referring to the following Detailed Description in conjunction with the accompanying drawings, in which like reference numerals indicate identical or functionally similar elements.

### DETAILED DESCRIPTION

Traditional approaches to obtaining wine recommendations can have several significant downsides. For example, the availability of a sommelier is extremely limited. They are typically employed only by high-end restaurants, leaving diners in most establishments, as well as customers in wine shops or those choosing a wine at home, without access to such expert guidance. In addition, many individuals feel intimidated when consulting with a sommelier, hesitant to reveal a limited budget or a lack of knowledge, which can lead to social pressure and potentially a more expensive or less suitable choice. Further, the quality of the recommendation is dependent on the individual sommelier's skill, experience, and even their current rapport with the customer, introducing an element of human variability and inconsistency.

In the absence of a sommelier, consumers are often left to their own devices. When faced with a lengthy wine list or a wall of bottles in a retail store, the selection process becomes a matter of guesswork based on limited information. A person might recognize a grape varietal, a region, or a producer, or they may simply choose based on price or an appealing label. This often leads to “safe” but unadventurous choices, where the consumer repeatedly buys the same few wines they know, missing the opportunity to discover new and potentially more enjoyable options. Further, this method rarely accounts for nuanced factors like the specific meal being eaten or the user's evolving taste profile.

While some digital applications have been developed to assist with wine selection, they too have shortcomings. Many existing applications serve as generic databases, providing information about wines only if the user manually searches for them. Others offer general food pairing rules (e.g., “Pinot Noir pairs well with duck”), but lack the ability to apply this advice to a specific, available list of wines. These tools are not personalized to an individual's unique palate and do not learn from the user's past choices and feedback. Further, such applications typically rely on two main sources of information: aggregated customer reviews from public websites and marketing descriptions supplied by the wine producers themselves.

The primary issue with relying on aggregated customer reviews is the lack of a consistent or calibrated frame of reference. A five-star rating from a novice who prefers sweet, simple wines is not equivalent to a five-star rating from an experienced connoisseur who appreciates complexity and structure. These applications treat all user opinions as equal, leading to a “tyranny of the average,” where popular, crowd-pleasing, or mass-market wines are consistently recommended, while lesser-known gems or wines with more nuanced profiles are overlooked. Furthermore, a negative review may not distinguish between a genuinely flawed bottle (e.g., one that is corked) and a well-made wine that simply did not suit that particular user's unstated preference. This aggregated data is noisy, subjective, and lacks the context needed for a truly tailored recommendation.

Similarly, descriptive data obtained from wine producers is inherently biased. A producer's tasting notes are marketing-driven, designed to present the wine in the most appealing light possible. They will highlight desirable characteristics while omitting any potential shortcomings. Thus, producer-provided data cannot be considered an objective source for making an informed decision. For these reasons and others, existing wine applications fail to replicate the key function of a sommelier: making a specific, tailored, and expert recommendation from a constrained list of currently available options.

Therefore, a need exists for a system that overcomes these limitations. There is a need for a convenient, accessible, and intelligent tool that can provide the personalized, context-aware expertise of a sommelier to any user, in any location. Such a system should be capable of understanding a user's unique and evolving preferences, automatically processing a list of available wines “on the fly” in real-time or near real-time (such as from a photograph of a wine list while at a restaurant), considering contextual factors like food pairings, and delivering personalized recommendations in an approachable manner, thereby empowering users to make confident choices and discover new wines.

Aspects of the present disclosure meet these needs and others by generating automatic wine recommendations using artificial intelligence (AI). A wine recommendation system can customize a machine learning model using exemplary wine selections made by particular users having particular characteristics (e.g., demographic data, preferences, historical wine selections, etc.) and/or made by trained sommeliers, wine definitions (for varietals generally and/or for specific wines made by specific producers for specific vintages), and role(s) the machine learning model should assume in selecting a wine (e.g., assuming the role of a restaurant's sommelier). Based on a user profile and available wines indicated on a wine list, the wine recommendation system can apply the customized machine learning model to select a wine for the user, which can further be based on contextual factors, such as a food being consumed, the user's environment (e.g., a party, a restaurant, outdoors, weather, etc.), and/or the like.

In some implementations, the system can be curated and trained by a professional sommelier, which can provide significant advantages over existing applications by replacing raw, often unreliable data aggregation with genuine, nuanced expertise. For example, a machine learning model trained by a sommelier can be built upon a foundation of professional, curated knowledge. A sommelier's expertise goes far beyond simple “likes” or “dislikes.” They are trained to deconstruct a wine into its core components (e.g., acidity, tannin, alcohol, body, and finish), and understand how these elements create balance and structure. They possess a deep, contextual understanding of how a wine's characteristics will interact with specific foods, considering factors like fat, salt, and spice in a dish. A sommelier can identify not just a “good” wine, but a wine that is a great value for its price, or one that is a classic representation (“typicity”) of its region and grape varietal.

By using a sommelier's expertise to create the initial training data and define the logic of the recommendation algorithm, the system can learn to think like a wine expert. The initial model is not trained on a noisy dataset of public opinion, but on a curated set of exemplary pairings and selections that reflect years of professional experience. The system can learn the principles of wine pairing and preference matching, rather than just correlating keywords from user reviews. This allows the system to make more accurate, adventurous, and ultimately more satisfying recommendations that can introduce a user to new wines they would love, but would never discover through conventional applications using reviews and popularity scores alone. Using a sophisticated, complex, nonconventional, and customized machine learning model, the system described herein can digitize the sommelier's palate and decision-making process, providing a level of personalized, expert guidance that simple data aggregation cannot replicate.

For example, while other wine recommendation applications can recommend wine based on generalizations, the system described herein can read a wine list and use past preferences to recommend new wines depending on what the user wants to experience at a restaurant (or other location, such as a wine store). In some implementations, a wine list can be uploaded as a whole, instead of one-by-one, to tell users what to order. In some implementations, the system can automatically obtain, download, and/or access restaurant wine lists, wine shops' inventories, grocery stores' inventories, etc., to determine available wines, if such information is available. In alternative or additional implementations, the user can take a picture of a wine list with a computing device, such as a camera integral with a mobile phone. The system can then perform text recognition, object detection, and/or object recognition techniques on the photograph to identify the available wines. In some implementations, however, it is contemplated the user can take pictures of individual wine bottles and/or labels, textually enter particular wines or the entire wine list, etc., and similar techniques as those described herein can be performed to identify and select wines.

Training data for the machine learning model described herein can be developed by a working wine professional (e.g., who has wine certifications such as certifications as an Advanced Sommelier, an Italian Wine Specialist, etc.). For example, the wine professional can at least partially initially train a machine learning model with particular wines or variety of wines paired with various characteristics, such as what wine goes with particular types of food, descriptors of the wine, etc. In some implementations, the model can further be initially trained based on data collected from other sources, such as the internet, databases storing information about wine, etc., as well as historical feedback data (e.g., user ratings), as described further herein.

In use, a user can launch application. Upon first launch, the user can use the application to build a profile. The profile can include a few simple questions, such as the user's favorite drink at home, what the user likes about wine, whether the user likes Old World or New World wine, price point, what the user is eating, etc., similar to the questions that a sommelier would ask a guest at a restaurant when ascertaining what wine to recommend based on the individual's palate. In some implementations, the profile can further include user data, such as user demographics (e.g., age, location, knowledge of wine, education, profession, etc.). In some implementations, the profile can automatically obtain user data from one or more third party sources, such as social media applications. Each time a wine is selected by a user, the system can add the wine (or descriptive features of the wine) to the profile to build and strengthen what the user likes or doesn't like. In some implementations, the user can also give a rating of the wine (e.g., on a scale or 1 to 5), and the machine learning model can be updated based on this feedback. Thus, the machine learning model can be highly personalized and customized for the user.

In some implementations, the system described herein can interface with other applications to enhance its utility and provide additional services and/or information, such as websites or applications that assist the user in pronunciation of particular wines, wine variety information from other sources, producer information, etc. For example, the system described herein can interface with language applications for wine pronunciation (including varietal, producer, etc.). In another example, the system described herein can interface with wine scoring applications to obtain wine scores, awards, and/or ratings (including sommelier or other professional ratings and/or user ratings). In still another example, the system described herein can interface with wine searcher applications to purchase favorite wines from retail establishments.

In some implementations, the system can select a best-selling wine from those identified by the machine learning model, a wine being promoted by a particular restaurant or producer (e.g., based on an affiliation of the system with particular restaurants and/or producers), and/or any other factors. In some implementations, the system can select a wine having a highest match score to the input data based on application of the machine learning model. In some implementations, if a user selects a price point that is too low for what they like to drink or what is recommended, the system can indicate that they need to spend more money to get a wine that they will enjoy. In some implementations, the system can present the user with a list of recommended wines, and the user can select a wine based on the provided list. In some implementations, the system can present the list in a particular order defined by a match score of the wines, based on the additional factor(s) described herein, etc. In some implementations, the system can select a wine from a list and present it to a user associated with an entity providing the wine (e.g., a sommelier or other representative of a wine store, a restaurant, etc.), based on user data and/or profile data for another user (e.g., a customer or potential customer).

In some implementations, after initial wine selection from the wine list by the user, by the system, and/or upon tasting and/or drinking of wine from the wine list by the user, the system can present one or more additional options. For example, the system can present an interface for the user to provide feedback on the wine upon drinking the wine, which can further be used to update the machine learning model. In some implementations, the system can present one or more questions to the user to gather information used to select their next wine, e.g., “Try something different?,” “Feeling adventurous?,” etc. This information can alternatively or additionally be used to refine and update the machine learning model to select one or more next recommended wines from the wine list.

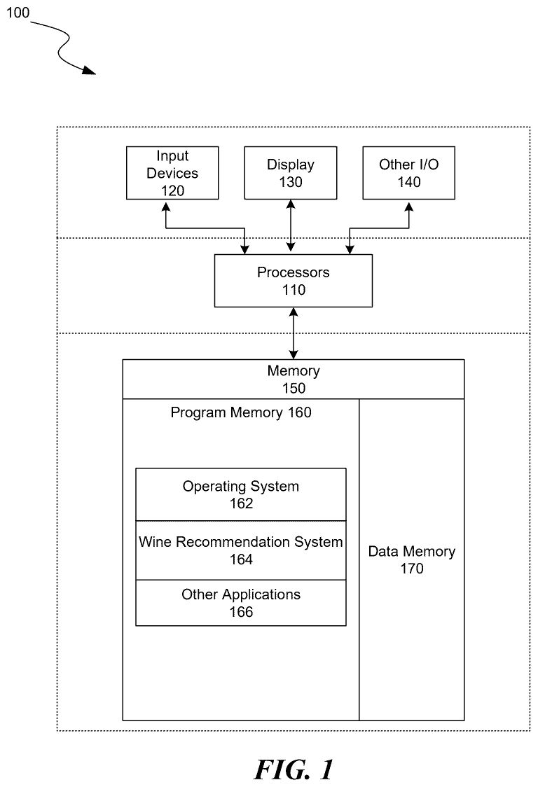

Several implementations are discussed below in more detail in reference to the figures. FIG. 1 is a block diagram illustrating an overview of devices on which some implementations of the disclosed technology can operate. The devices can comprise hardware components of a device 100 that can automatically recommend wines. Device 100 can include one or more input devices 120 that provide input to the Processor(s) 110 (e.g., CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera-or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, wine recommendation system 164, and other application programs 166. Memory 150 can also include data memory 170, e.g., wine data, wine list data, varietal data, customization data, training data, feedback data, profile data, user data, third party data, role data, configuration data, settings, user options or preferences, etc., which can be provided to the program memory 160 or any element of the device 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

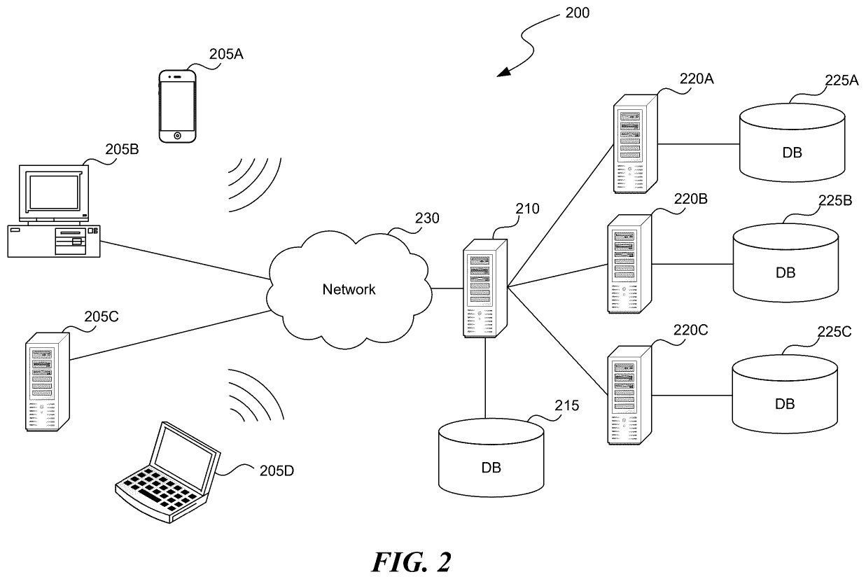

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as wine data, wine list data, training data, feedback data, profile data, user data, third party data, and/or the like. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

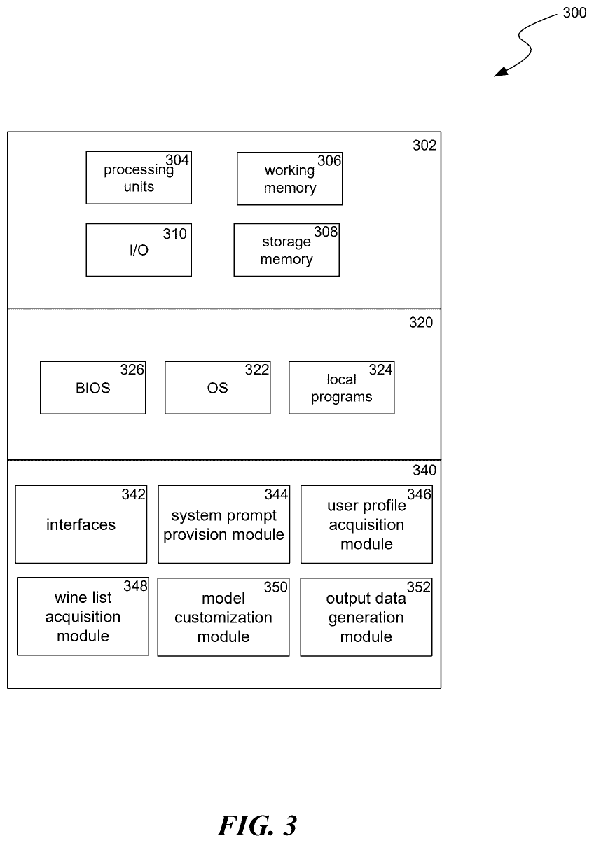

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include system prompt provision module 344, user profile acquisition module 346, wine list acquisition module 348, model customization module 350, output data generation module 352, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

System prompt provision module 344 can provide a system prompt defining customizations for a machine learning model. The customizations can include A) a set of exemplary wine selections, each exemplary wine selection being correlated with one or more exemplary user profiles (e.g., characteristics, preferences, etc., of users that selected or would selected that wine), B) wine definitions for multiple wine varietals, and, in some implementations, C) role definition(s) defining one or more roles that the machine learning model can assume and/or guidelines for the machine learning model to select a role for various user inputs. In some implementations, the machine learning model can be or can implement a large language model (LLM). The A) set of exemplary wine selections can serve as a training guide, showing the model what a “good” recommendation looks like. Each example can be linked to a specific user profile or a natural language command that prompted it. A wine selection can be considered “good,” for example, if it has received positive feedback, which can be explicit or implicit. In another example, a wine selection can be considered “good” if it was made or confirmed by a sommelier.

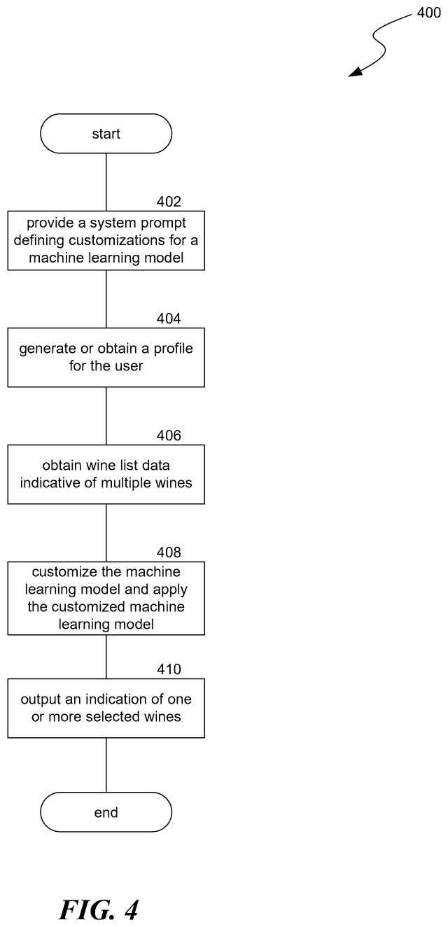

The B) wine definitions can act as the machine learning model's knowledge base. These definitions can be very general, describing the common characteristics of a grape varietal like Chardonnay, or they can be highly specific, detailing the unique features of a particular bottle from a specific producer and vintage. The C) role definition(s) can allow the machine learning model to adopt different personas such as a creative “brainstormer,” a helpful “friend,” or an “expert sommelier.” When multiple roles are available, the system prompt also provide guidelines for how the model should choose the most appropriate role for any given situation (e.g., for a user with limited wine knowledge and experience, take on an “owner” and “introductory sommelier” role, and select a single, approachable wine on the user's behalf. In some implementations, however, it is contemplated that the machine learning model can always adopt a single role defined by the system prompt, e.g., “sommelier” or “wine expert.” Further details regarding providing a system prompt defining customizations for a machine learning model are described herein with respect to block 402 of FIG. 4.

User profile acquisition module 346 can generate or obtain a profile for the user for which the wine(s) will be recommended. The user profile can include one or more of user preferences, user data (e.g., user demographic data, user historical wine purchases, etc.). For example, user profile acquisition module 346 can create a detailed profile for the user to understand their tastes. This process can begin by prompting the user with a series of questions through a user interface. These questions might include inquiries about their favorite drink at home, their price point, and whether they prefer Old World or New World wines. Beyond these initial preferences, the user profile can be enriched with additional layers of data. This can include demographic information such as age, location, and self-assessed wine knowledge. In some implementations, the user profile can also maintain a comprehensive history of the user's interactions with wine. This history can track not only which wines the user has previously tried and how they rated them (e.g., on a 1-to-5 scale), but also their browsing and search activity, revealing their curiosities about specific wines, regions, or producers even when they don't make a selection or purchase. Further details regarding generating or obtaining a profile for a user are described herein with respect to block 404 of FIG. 4.

Wine list acquisition module 348 can obtain wine list data indicative of multiple wines available at a location, such as a restaurant, a wine store, or even a personal wine cellar. This can be accomplished in two primary ways: by analyzing an image or by automatically retrieving data from an online source. In a first example, the user can use their mobile device's camera to capture an image of the wine list. This can be a picture of an entire restaurant wine list, a specific section of interest (like only Italian wines), or even individual bottle labels if they are in a cellar or being shown specific bottles. Wine list acquisition module 348 can use technologies like text and object recognition to analyze the image and convert the visual information into a machine-readable list of available wines.

Alternatively or additionally, wine list acquisition module 348 can retrieve the wine list automatically, without requiring the user to take a photo. This is often done by using the mobile device's location (via GPS or other methods) to identify the specific restaurant or store that the user is in. Once the business is identified, wine list acquisition module 348 can attempt to connect directly to the establishment's internal computing system to obtain its inventory list. As another approach, the system can simply search the internet using the business's name to find the wine list on the company's website or on third-party review sites. Further details regarding obtaining wine list data indicative of multiple wines are described herein with respect to block 406 of FIG. 4.

Model customization module 350 can customize the machine learning model and apply the customized machine learning model to input data including the profile of the user and the wine list data. In some implementations, the input data can further include a user prompt requesting generation of wine recommendation(s). This request can be made using natural language and can be either explicit (e.g., “choose a wine from this list with these attributes”) or implicit (e.g., “tell me about wines that might pair well with this food”). The prompt can be made by various input methods, such as verbal commands spoken by the user, which can be captured by a microphone and transcribed into text using speech recognition, or the user can simply type their request into a user interface. In some implementations, the input data can further include contextual data. This context can include a wide array of information, such as: audio, images, and video from a mobile device's sensors; environmental factors like the weather and time of day; and the user's GPS location, which can identify if they are at home or at a specific restaurant. The context need not be limited to the present moment; it can also incorporate the user's historical actions (like past locations visited) and even business-related factors, such as special promotions for certain wines at certain restaurants or establishments.

Model customization module 350 can apply the customizations, from the system prompt, to the machine learning model causing the machine learning model to respond to the input data x) based on the set of exemplary wine selections, y) with one or more wine varietals selected based on the wine definitions and the input data, and z) with the machine learning model assuming a role according to the role definition(s) and the input data. Model customization module 350 can select, by the customized machine learning model, one or more wines of the multiple wines indicated by the wine list data that are of the selected varietal(s) based on the input data. In some implementations, the model's response can be guided by the initial expert configurations from the system prompt. This means it can select a wine based on, for example: the “good” examples it was trained on; Its deep knowledge of wine varietals, which it uses to pick a specific, available bottle; and the persona or “role” (e.g., expert sommelier, brainstormer, etc.) it has been instructed to assume for this particular user and context.

To ensure a high-quality recommendation, in some implementations, the customized machine learning model can include a self-evaluation step. After selecting a wine, it can calculate a “confidence score” or “match score” to measure how well its choice meets all the user's requirements and/or preferences. If the score is above a certain threshold (e.g., 80%), the recommendation can be presented to the user by output data generation module 352. If the score is too low, the customized machine learning model doesn't just return a poor match; instead, it can re-prompt the model with new instructions (e.g., “focus more on the user's price preference”) and makes it try again to find a better selection. Further detail regarding customizing a machine learning model and applying a customized machine learning model to input data are described herein with respect to block 408 of FIG. 4.

Output data generation module 352 can output an indication of the one or more wines selected by the customized machine learning model. In some implementations, output data generation module 352 can generate a user interface with such an indication, and cause display of the generated user interface. This can happen on the device's own built-in screen or by sending the necessary rendering data to a separate display device. The user interface can be versatile and can be displayed on a variety of devices, including tablets, smartphones, smart watches, or even augmented reality (AR) glasses. Output data generation module 352 can adapt the user interface based on the specific device's capabilities and limitations, taking into account factors like screen size, resolution, processing power, and available battery life.

Furthermore, the output need not be limited to just a visual display; it can be a multi-sensory experience incorporating audio and haptic feedback in some implementations. For instance, output data generation module 352 can generate a voice response, powered by a large language model, that verbally describes the recommended wine's name and/or features. In some implementations, the large language model can also engage the user in a continued conversation by asking follow-up questions, which may alternatively or additionally be presented visually on the user interface. Any additional information garnered can be used to update the results provided by the customized machine learning model. Further details regarding outputting an indication of one or more wines selected by a customized machine learning model are described herein with respect to block 410 of FIG. 4.

Those skilled in the art will appreciate that the components illustrated in FIGS. 1-3 described above may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for automatically recommending wine to a user. In some implementations, one or more steps of process 400 can be performed by a computing device, such as a computer, a mobile device, a smartphone, a tablet, a laptop, a wearable device (e.g., a smart watch, smart glasses, etc.), an extended reality (XR) system (e.g., augmented reality (AR) glasses), and/or other electronic device or system of devices. In some implementations, one or more steps of process 400 can be performed by external processing components in operable communication with an electronic device. In some implementations, one or more steps of process 400 can be performed by a computing system remote from the device or system requesting a wine recommendation, providing user profile data, and/or providing a wine list, such as one or more servers, which can include a cloud or edge computing system in some implementations.

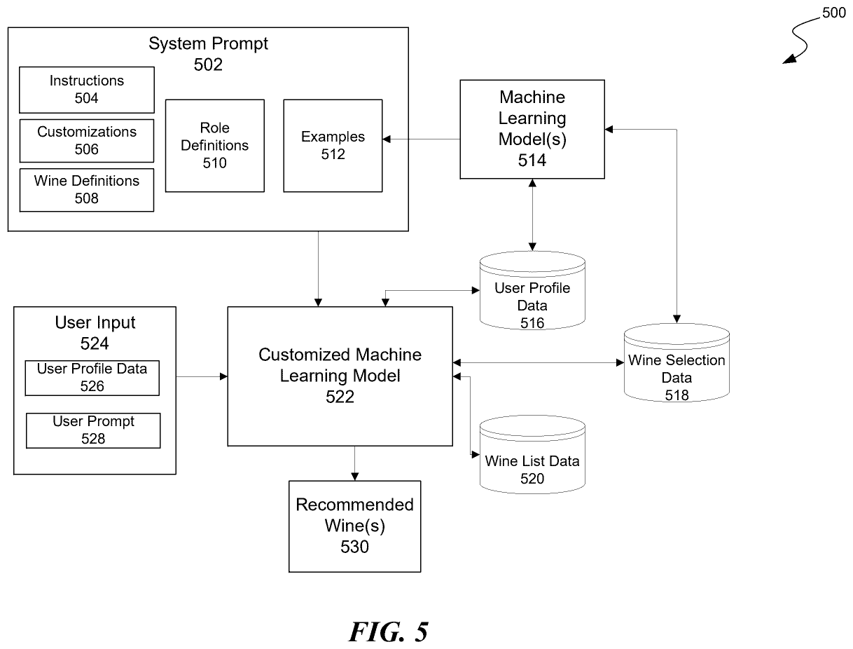

In some implementations, process 400 can be performed by wine recommendation system 164 of FIG. 1. In some implementations, process 400 can be performed by specialized components 340 of FIG. 3. In some implementations, at least a portion of process 400 can be performed by customized machine learning model 522 of FIG. 5.

In some implementations, process 400 can be performed based on a user-level, application-level, or system-level request to generate wine recommendation(s) “on the fly,” e.g., at runtime upon receipt of the request. In some implementations, the user requesting the wine recommendation(s) can be the person who will be consuming the wine (e.g., a restaurant patron, a wine store patron, a person preparing a meal at home, etc.). In some implementations, the user requesting the wine recommendation(s) can be a person other than the person who will be consuming the wine, such as a representative (e.g., a sommelier or employee) of an entity (e.g., a restaurant, a wine store, another retail store selling alcohol, a wine distributor, a wine purchaser, a wine wholesaler, etc.), a person with a personal wine cellar selecting wine(s) for other(s), a person preparing a meal and/or wine tasting at a residence for other(s), etc.

At block 402, process 400 can provide a system prompt defining customizations for a machine learning model. In some implementations, the machine learning model can be a large language model (LLM). In some implementations, the customizations can include a set of exemplary wine selections. Each exemplary wine selection can be correlated with one or more exemplary user profiles. In some implementations, one or more exemplary wine selection can alternatively or additionally be correlated with a natural language command for which a wine selection was made. In some implementations, the set of exemplary wine selections can be designated as “good wine selections,” i.e., wine selections that have received implicit or explicit positive feedback by the user or another user for which such wine was previously selected. The positive feedback can include, for example, a user selecting an option that the wine met their requirements and/or preferences (e.g., a “thumbs up” icon), a user leaving a positive rating for a wine (e.g., a rating of 7/10 or higher), a user failing to request an alternative recommendation, etc. In some implementations, the customizations can include wine definitions for multiple wine varietals, which can include, for example, general descriptions of generic wine varietals (e.g., common features of the same type of wine), and/or specific descriptions of specific bottlings of varietals (e.g., features of a particular wine of a particular vintage and from a particular producer).

In some implementations, the customizations can include one or more role definitions defining role(s) the machine learning model can assume (e.g., “brainstormer,” “friend,” “expert sommelier,” etc.). When the customizations include multiple role definitions defining multiple roles the machine learning model can assume, the customizations can further include guidelines for the machine learning model to select a role for various user inputs. In some implementations, the guidelines can define how the machine learning model determines what level of support a user is looking for, ranging from getting a second opinion, getting more information, or outsourcing the selection of wine completely. In some implementations, the guidelines can specify how the machine learning model should select the role based on a user prompt, user profile (which can indicate, for example, a level of knowledge, experience, and/or sophistication of the user relative to wine), tone, situation, and/or other context, which can include data obtained from third-party applications or systems. In some implementations, the guidelines for the machine learning model to select the role can define types of user profile data mapped to particular roles. For example, a request for choosing a wine on behalf of the user can be mapped to an “owner” role, while a request asking for suggestions and/or more information can be mapped to a “brainstormer” role. Further, user profile data indicating that the user has a high level of knowledge about wine can be mapped to an “advanced sommelier” or “master sommelier” role, rather than an “introductory sommelier” or “friend” role.

At block 404, process 400 can generate or obtain a profile for the user. In some implementations, the profile can include preferences of the user. For example, process 400, via a user interface, can prompt a user to build the user profile. In some implementations, process 400 can obtain information from the user via a series of queries, such as the user's favorite drink at home, what the user likes about wine, whether the user likes Old World or New World wine, price point, what the user is eating, etc. In some cases, these questions can be similar to questions that a live comelier would ask a guest at a restaurant when ascertaining what wine to recommend based on the individual's palate.

In some implementations, the user profile can further include user data, such as user demographics (e.g., age, location, knowledge of wine, education, profession, etc.). In some implementations, process 400 can automatically obtain user data from one or more third-party computing systems, such as social media applications and/or data on a social graph. In some implementations, the user profile can include a history of wines previously tried by the user, whether the user liked or didn't like the wine, a rating of the wine (e.g., on a scale of A to F), etc. In some implementations, the user profile can further include browsing and/or search history, such as what wines, regions, or producers the user searches for; which recommended wines do they tap on to read more details about; etc., which can be indicative of their interests and curiosities, even if they do not make a purchase.

In some implementations, process 400 can further obtain, as input, a user prompt requesting recommendation of one or more wines. In some implementations, the user prompt can be a natural language user prompt. The request to obtain wine recommendation(s) can be explicit (e.g., “choose a wine from the wine list that has these attributes”) or implicit (e.g., “tell me more about some wines that might pair well with this food”). In some implementations, the user prompt can include verbal input spoken by the user of the system performing process 400, or another user around the user of the system, and detected by one or more microphones. To process a natural language verbal command, process 400 can apply speech recognition and/or natural language processing techniques to transcribe the natural language verbal command into machine-readable text. In some implementations, the user input can include textual input, e.g., entered on a virtual or physical keyboard.

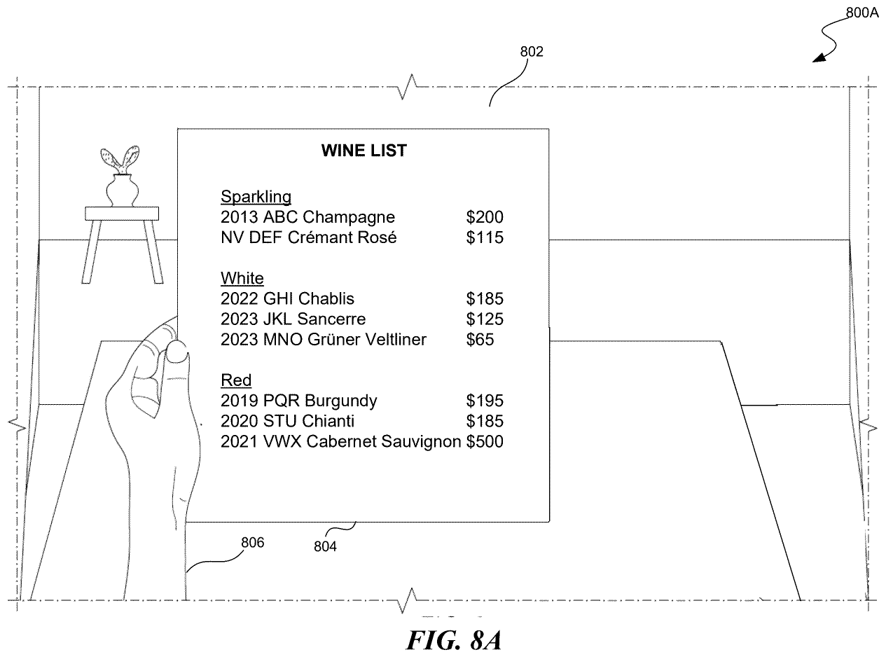

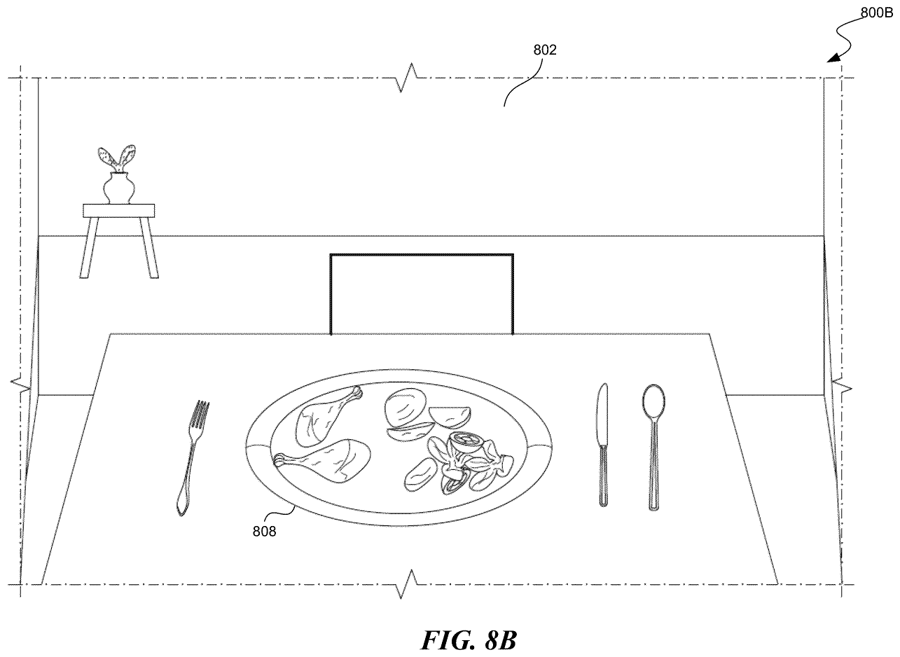

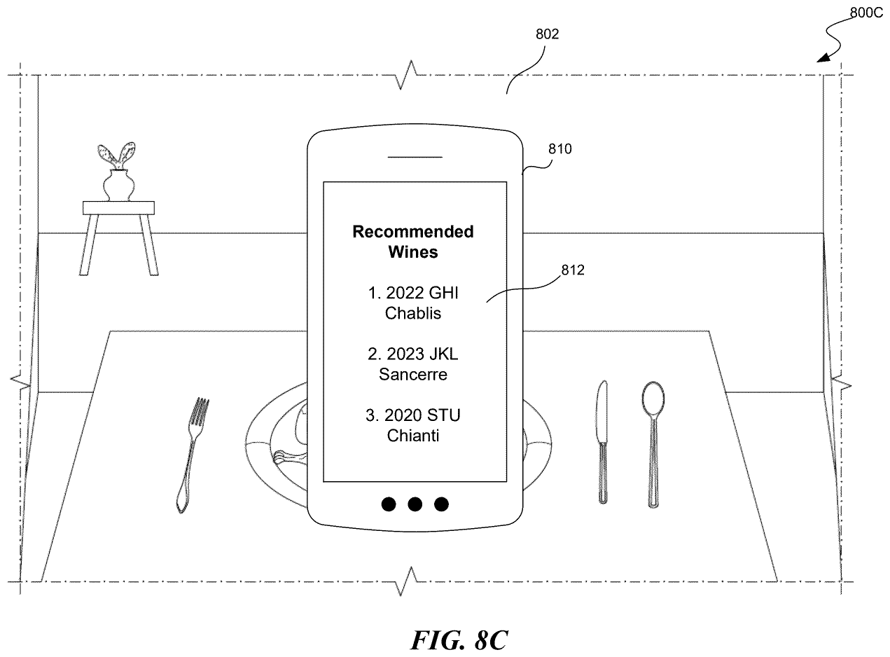

In some implementations, process 400 can further obtain, as input, context data, such as context for a real-world environment surrounding the user. In some examples, the context can include any data related to the real-world environment captured by one or more sensors or otherwise obtained by process 400. For example, the context can include audio, image(s), video(s), environmental factors (e.g., weather, ambient light, etc.), data from third-party sources (e.g., traffic conditions, date, day of the week, month, time of year, etc.), location (e.g., as determined from a GPS system, which can include a residential location, a business location such as a restaurant, etc.), and/or the like. In some implementations, the context can include historical actions taken by the user of the system in the real-world environment, types of applications and/or UIs interacted with by the user and how they were used, locations visited by the user, etc. In some implementations, the context can include business and/or marketing context, such as promotions for particular wines, established associations with particular wine producers, contractual obligations to sell particular amounts of particular wines, etc. In some implementations, the context can alternatively or additionally be captured or obtained by one or more sensors of another system, such as one or more wearable or smart devices, an XR system or other sensing device, etc. In some implementations, the context can include one or more identified objects captured in one or more images. For example, process 400 can capture image(s) of the real-world environment surrounding the system via one or more cameras. Process 400 can then perform object recognition techniques to identify the objects in the real-world environment surrounding the system. A specific example in which image(s) of food are captured to provide contextual data for a machine learning model is described herein with respect to FIG. 8B.

At block 406, process 400 can obtain wine list data indicative of multiple wines, such as wines available from an entity, such as a restaurant, a retail store, a personal wine cellar, etc. In some implementations, the wine list data can be obtained from one or more images captured by a camera of a mobile device of the user. For example, the mobile device can capture image(s) of the entire available wine list or portion(s) thereof (e.g., only portion(s) including wines of interest to the user, such as only white wines, only wines from France, etc.). Process 400 can then perform text recognition, object detection, and/or object recognition techniques on the image(s) to convert the wine list image into a machine-readable format. In some implementations, the wine list data can be obtained by the user uploading photos of labels of available bottles of wine, such as when the user is in a wine cellar and/or is shown particular bottles of wine from which to choose, and identifiers of the wine can be similarly extracted.

In some implementations, the wine list data can be obtained from a computing system associated with an entity providing wine, such as a restaurant, a retail store, etc. In some implementations, process 400 can identify the entity providing the wine based on an obtained location of the mobile device of the user. For example, process 400 can cause the mobile device to obtain its location via a GPS system and/or other location-sensing components and/or processes, such as triangulation. Process 400 can then query a third-party computing system, such as a mapping system, to determine a business (e.g., restaurant, wine store, etc.) at that location. Process 400 can further identify a computing system associated with the entity, and obtain the wine list data from the entity via the entity computing system. In another example, process 400 can query the Internet, search engines, etc., for the wine list associated with the entity (e.g., based on the entity name, the entity's website, a review website, etc.).

At block 408, process 400 can customize the machine learning model and apply the customized machine learning model to input data including i) the profile of the user and ii) the wine list data. In some implementations, and as described above, the input data can include a user prompt and/or context data. In some implementations, process 400 can apply the customizations, from the system prompt, to the machine learning model causing the machine learning model to respond to the input data x) based on the set of exemplary wine selections, y) with one or more wine varietals selected based on the wine definitions and the input data (e.g., one or more wine varietals, which can include a specific bottle of wine, available on the wine list), and z) with the machine learning model assuming a role according to the role definition(s) and any available guidelines, as described further herein.

In some implementations, process 400 can calculate a confidence score for whether the response to the user input (i.e., the selected wine(s)) meets the requirements of the input data. For example, process 400 can generate a match score between the input (e.g., mapped features of the user input and any context) and the response to the user input (e.g., selected wine(s)) by projecting such features as vectors into a classification space and calculating a difference between the input and the proposed response. In some implementations, the customized machine learning model can self-evaluate to assess its own confidence and provide a match score. The match score can be any numerical or textual value or indicator, such as a statistic or percentage. In some implementations, process 400 can proceed to output the selected wine when the match score is above a threshold, e.g., 70%. Otherwise, process 400 can modify the system prompt and/or make a new prompt instructing the machine learning model on how to reselect one or more of the wine(s) to increase the match score and better meet the requirements of the user input (e.g., emphasizing particular portions of the user input, such as user preferences).

Although shown and described herein as process 400 applying the customizations from the system prompt to the machine learning model after obtaining the user input, thereby causing the machine learning model to respond to the user input, it is contemplated that, in some implementations, process 400 can apply at least some of the customizations to the machine learning model before obtaining the user input. For example, process 400 can filter the set of exemplary wine selections for wine selections receiving positive feedback, the most recently selected wines (e.g., wines selected within a threshold amount of time of the time process 400 is executed), etc.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the trained model can be a neural network with multiple input nodes that receive input data including user profile data, wine list data, user request data, and any contextual factors. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer,”) one or more nodes can produce a value classifying the input that, once the model is trained, can be used to recommend one or more wines responsive to the input data. In some implementations, such neural networks, known as deep neural networks, can have multiple layers of intermediate nodes with different configurations, can be a combination of models that receive different parts of the input and/or input from other parts of the deep neural network, or are convolutions or recurrent—partially using output from previous iterations of applying the model as further input to produce results for the current input.

A machine learning model can be trained with supervised learning, where the training data includes known wine selections by users having known user profiles, known wine selections by sommeliers and associated descriptions, user requests, any user metadata, and any contextual factors as input and a desired output, such as a prediction of wine(s) from a wine list. Profile data associated with a user and a wine list can be provided to the model. Output from the model can be compared to the desired output (i.e., a known wine selection), and, based on the comparison, the model can be modified, such as by changing weights between nodes of the neural network or parameters of the functions used at each node in the neural network (e.g., applying a loss function). After applying each of the factors in the training data and modifying the model in this manner, the model can be trained to evaluate new input data.

Some implementations of the wine recommendation system can include a deep learning component. A “deep learning model,” as used herein, refers to a construct trained to learn by example to perform wine selection directly from user input data, including user profiles and wine varietals. The deep learning model is trained by using a large set of labeled data and applying a neural network as described above that includes many layers. The deep learning model in some implementations can be a convolutional neural network (CNN) that is used to automatically learn a user profile's inherent features (and/or inherent features of contextual data) to identify wine selections appropriate for that user profile. For example, the deep learning model can be an R-CNN, Fast R-CNN, or Faster-RCNN.

At block 410, process 400 can output an indication of the selected one or more wines. In some implementations, process 400 can generate a user interface including the indication of the selected one or more wines. In some implementations, process 400 can further cause display of the generated user interface. In some implementations in which the system performing process 400 has a display, process 400 can display the generated user interface. In some implementations in which process 400 is in operable communication with a separate display device, process 400 can provide rendering data for the generated user interface to the display device, thereby causing display of the generated user interface on the display device.

In some implementations, the generated user interface (or a version or derivative thereof) can be displayed on a smartphone, on smart glasses (e.g., augmented reality (AR) glasses), and/or on another wearable device, such as a smart watch. In some implementations, the user interface can be generated and/or modified based on the constraints and/or requirements of the display device (e.g., hardware and/or software constraints and/or requirements). Such constraints and/or requirements can include, for example, display features (e.g., resolution, refresh rate, panel type, two dimensional rendering capability, three dimensional rendering capability, etc.), power availability (e.g., battery charge level, whether the device is plugged in, power usage of the display, etc.), processing speed, available memory, available storage, size, etc.

In some implementations, process 400 can further cause rendering of audio and/or haptics features alongside the visual user interface display. For example, the generated user interface can be accompanied by a voice response describing the selected wine(s) and/or one or more of its features. In some implementations, the voice response can be generated by a large language model. In some implementations, the voice response can ask follow-up questions to obtain further user input for updating and/or re-predicting the selected wine(s) or a portion thereof. In some implementations, such follow-up questions can alternatively or additionally be presented on the user interface. Thus, in some cases, the visual and/or voice response can facilitate continued conversation with the user, and continual updating of the machine learning model and/or its results.

In some implementations, to generate the user interface, process 400 can initially generate structured output data representative of the selected wine(s). The structured output data can have a fixed, predefined schema (e.g., a standardized format) that can be read, interpreted and translated to generate the user interface. In some implementations, the structured output data can be in an HTML, CSS, and/or JavaScript format, allowing for ease of implementation, flexibility, and inclusivity of logic and interactivity.

In some implementations, process 400 can translate the structured output data into a generated user interface. Process 400 can translate the structured output data into the generated user interface using specialized user interface building components. For example, process 400 can read and interpret the code defining the structured output data, which can include wine descriptor(s) and/or definition(s) that should be used in the user interface, specific and/or generic wine image(s) that should be used in the user interface (which, in some cases, can include links or pointers to where such images are available), templates and/or primitives for presenting and/or organizing such data and/or images in the generated user interface, features of the user interface selected or arranged based on the wine definitions and/or role definitions, etc. For example, process 400 can customize the user interface by translating the structured output data into the user interface (including its layout, selection of data and user interface elements, arrangement of user interface elements, visual features, colors, etc.) according to the wine definition(s), role definition(s), template(s), etc., which can be dynamically selected for each generated user interface based on the user input and/or any other context. For example, a selected “master sommelier” role can define that more complex, nuanced information about a set of wines be provided on the user interface, while a selected “owner” role can present only limited information about a single selected wine in a simple presentation, as additional information is not needed by the user based on the customized machine learning model assuming ownership of the task on behalf of the user.

In some implementations, process 400 can further receive, via the displayed user interface, a user selection of a wine, of the predicted one or more wines. For example, the user selection can be an interaction event relative to a user interface element (“UI element”) representative of a particular wine of the predicted wine(s) presented on the user interface. In some implementations, the UI element can include one or more natural language descriptors, e.g., a name of a wine, a type of a wine (e.g., red, white, sparkling, rose, flat, a varietal, etc.), a producer of a wine, etc. In some implementations, the UI element can be interactive (e.g., a button, a hyperlink, etc.). The UI element can include textual and/or visual elements, such as an image of the bottle of wine obtained from one or more third-party computing systems.

The interaction event can include any action indicative of an intent to interact with a UI element, representative of a particular wine, displayed on the user interface, made directly or indirectly by the user. For example, the interaction event can be a selection of a UI element on a touchscreen, a verbal announcement that references a UI element, a point-and-click of a mouse or controller relative to the UI element, selection of a physical button corresponding to a UI element, etc. In some implementations, such as when process 400 (or a portion thereof) is executed by an XR system or another device or system having camera(s) and associated processing capabilities, the interaction event can include a hand gesture detected on or within a threshold distance of a UI element in the environment (e.g., a pinch gesture in an XR environment), a gaze dwell of the user's eyes directed toward the UI element in the environment for longer than a threshold amount of time, selection via a controller, etc. In some implementations, the interaction event can be the user pointing to a particular wine on the wine list in the real-world environment.

In some implementations, upon receiving selection of a wine (e.g., selection of a rendered UI element corresponding to the wine, pointing at a particular wine on the wine list in the real-world environment, etc.), process 400 can obtain additional data associated with the wine selected by the user, which, in some implementations, can be obtained from third-party database(s), from opensource information, from the Internet, from one or more data store(s), etc. The additional data can include, for example, wine description data, tasting note data, vineyard data, pricing data (e.g., retail or wholesale pricing), availability data (e.g., where the wine can be purchased, such as retail stores and/or restaurants within a threshold distance of a location of the mobile device as determined by GPS), volume data (e.g., 750 mL, 1.5 L, etc.), varietal data (e.g., types of grapes used to make the wine and/or percentages of various types of grapes used to make the wine), aging data (e.g., how long the bottle was aged and how it was aged, what year the wine was bottled, how the wine is aging, etc.), skin contact data, harvest data, release data (e.g., when the bottled wine was released for purchase), winemaker data, producer data, or any combination thereof. However, it is contemplated that, in some implementations, some or all of this additional data can alternatively or additionally be provided on the user interface for each of the predicted one or more wine(s) on the user interface without user selection of a particular wine. Process 400 can then update the user interface with the additional data associated with the user-selected wine.

In some implementations, upon receiving selection of a wine, process 400 can store an indication of which wine was selected. In some implementations, process 400 can further prompt the user, via the user interface, to rate the wine (e.g., from 1 to 5 stars) and/or provide a written review of the wine. In some implementations, process 400 can provide such wine selection and/or rating data to one or more third-party computing systems, such as computing systems associated with a restaurant or retail store. In some implementations, process 400 can monetize providing this data to such entities.

In some implementations, process 400 can store information about predicted and/or user-selected wine(s) (including previously consumed wine(s) stored in a user profile) in a standardized format in one or more network-based non-transitory storage devices having a collection of wine data stored thereon. Process 400 can provide remote access to various users and/or computing systems over a network, such that any one of the users and/or computing systems can update the information about any of the wines having data stored in the collection in real-time, such as through a graphical user interface. In some implementations, the users and/or computing systems can provide such information in a non-standardized format. For example, the information can include images of wine bottles, textual descriptors, numerical ratings, etc. In some implementations, the non-standardized format of the data can be dependent on the hardware and software platform used by one of the users and/or computing systems and its requirements and/or constraints, as described further herein, such as processing constraints, display constraints, power constraints, storage constraints, etc. Process 400 can convert the non-standardized updated information into the standardized format, and store it in the standardized format in the collection of wine data.

Whenever updated information about predicted and/or user-selected wine(s) is stored, process 400 can automatically generate a message including the updated information about the wine(s), and transmit the message to the users having remote access to the collection of wine data (e.g., the mobile device, the computing system of the entity providing wine, other computing system of other entities providing wine, third-party computing systems, etc., which, in some cases, can include all of the users that are provided remote access to the collection of wine data) in real-time or near real-time. In some implementations, the message can be in the form of an updated user interface. Thus, the user(s) have immediate access to up-to-date information for wine(s) previously purchased and/or consumed, currently purchased and/or consumed, and/or being considered for purchase and/or consumption. For example, a user considering ordering wine(s) selected by the machine learning model can have immediate access to the most up-to-date information regarding those wines, enabling the user to make a more informed decision. In some implementations, process 400 can further feed the updated information to the customized machine learning model in real-time or near real-time, and the customized machine learning model can update, refine, and/or confirm its selection(s), resulting in improved accuracy in predictions that can be communicated to the user in real-time or near real-time, enabling more informed and timely user selections at runtime.

FIG. 5 a block diagram illustrating a system 500 of inputs to and outputs from a customized machine learning model 522 for automatically recommending wine to a user. In some implementations, customized machine learning model 522 can be included in wine recommendation system 164. In some implementations, customized machine learning model 522 can perform similar functions as those described with respect to one or more blocks of specialized components 340 of FIG. 3, as described further herein. In some implementations, customized machine learning model 522 can perform one or more blocks of process 400 of FIG. 4, as described further herein. In some implementations, customized machine learning model 522 can be, implement, or utilize a large language model (LLM).

Customized machine learning model 522 can receive, as input, system prompt 502. System prompt 502 can include instructions 504, customizations 506, wine definitions 508, role definitions 510, and examples 512. In some implementations, instructions 504 can include natural language describing what customized machine learning model 522 should accomplish, e.g., “make a wine recommendation from a wine list (e.g., wine list data 520) according to user input (e.g., user input 524).” Instructions 504 can further specify how customized machine learning model 522 should be specialized according to customizations 506 in order to generate a response (e.g., recommended wine(s) 530). In some implementations, instructions 504 can specify how customized machine learning model 522 is to output data, e.g., informing customized machine learning model 522 that the output to produce is data structured in a particular way (i.e., according to a structured output data format, according to a standardized format, etc.). For example, instructions 504 can tell machine learning model 522 that the result needs to include HTML or JavaScript code; be in an XML or JSON structure with specified fields; be in Basic, Python or PHP code; etc., which can be used for generating a user interface upon which recommended wine(s) 530 are displayed.

In some implementations, customizations 506 can uniquely specialize machine learning model 522 by having machine learning model 522 select and provide results according to instructions 504 and examples 512, rather than merely making direct predictions based solely on the text of the input (e.g., user input 524 and wine list data 520). In other words, customizations 506 can direct customized machine learning model 522 how to build a response (e.g., how to select and present recommended wine(s) 530), rather than simply selecting what appears to be the most statistically suitable available response. For example, customizations 506 can direct customized machine learning model 522 to select and/or provide the response according to user profile data 526 (regardless of the most suitable available response statistically), or to weigh user profile data 526 (including, for example, particular user preferences) more than the most statistically suitable response, such as if sufficient and/or relevant preference data is available.

Customizations 506 for machine learning model 522 can include, for example, wine definitions 508 for multiple exemplary wines and/or wine varietals (such as that may be included in examples 512) that customized machine learning model 522 can select from, and guidelines for selecting the wines based on various user profile data 516 and/or user prompts (e.g., based on particular user input 524). Some exemplary wine definitions 508 can include descriptors of wine such as core structural components (e.g., acidity, tannin, body, sweetness, alcohol), aroma and flavor profile (e.g., fruit, floral, spice, herb, savory, earth, mineral), production and origin data (e.g., varietal data including the type of grape(s) used, vineyard data, aging data, skin contact data, harvest data, release data, winemaker data, producer data), stylistic and categorical descriptors (e.g., Old World versus New World, color/type, price point), and/or the like. In some implementations, wine definitions 508 can describe particular varietals of wine in general, and/or describe particular bottles of wine for particular vintages.

In some implementations, in system prompt 502, wine definitions 508 can define their respective attributes, and the guidelines can instruct customized machine learning model 522 to select such wine(s) (e.g., particular bottles and/or wine varietals) not only based on user prompt 528, but also user profile data 526, which can include preference data, as well as contextual data such as tone, situation, conversation history, previously selected wines, environmental context, and/or knowledge about the user. By using this multi-faceted combination of structural, sensory, and factual descriptors of wine definitions 508, as well as user profile data 526 (and in some cases, user prompt 528), the system can move beyond simple keyword matching found in other applications. It can, for example, understand that a user who enjoys a specific “full-bodied, high-tannin Napa Cabernet” might also enjoy a “similarly structured, but more earthy, Bordeaux from a good vintage,” even if the flavor profiles are different. This ability to reason based on a wine's fundamental characteristics and user input 524 can allow the system to function like an expert sommelier.

In some implementations, customizations 506 can include role definition(s) 510 for one or more roles that customized machine learning model 522 can assume and, in the case of multiple defined roles, guidelines for customized machine learning model 522 to select a role based on various user profile data 516 (e.g., based on particular user input 524). A “role,” as used herein, can define a specific persona, function, or character that machine learning model 522 is intended to assume. For example, in general, a role may instruct the machine learning model to act as a helpful customer service operator for a financial institution, a technical support assistant for a software product, a creative assistant for generating marketing copy, etc. By defining a role, the system constrains machine learning model 522's responses to a relevant and appropriate domain, improving the predictability and utility of its output.

In system prompt 502, role definition(s) 510 can define attributes of the various roles depending on, for example, the level of support requested by user prompt 528 in selecting a wine; the level of knowledge of the user regarding wine (e.g., as indicated by education, profession, certifications, awards, wine purchase history, wine reviews, etc.) inferred from user profile data 526; and/or the like. The guidelines can instruct customized machine learning model 522 to select a role based not only on user input 524, but also tone, situation, conversation and/or interaction history, and knowledge about the user. As described further herein, exemplary roles defined in customizations 506 can include “brainstormer,” “owner,” “sommelier,” varying levels of sommelier (e.g., introductory, certified, advanced, or master), wine certification specialists (e.g., “Champagne Expert”) and others, with each having distinct approaches to selecting and presenting individualized results, as described further herein.

In some implementations, examples 512 can include a set of exemplary wine selections (from wine selection data 518) paired with synthetic or actual user profiles (from user profile data 516) for users making such selections, and/or in some cases, synthetic or actual prompts for selecting such wines (e.g., “I want a dry red wine,” “I want something that pairs well with fish,” etc.). In some implementations, customized machine learning model 522 can select wine(s) from such exemplary wine selections (or use them as guidance), using guidelines for selecting wines based on various user input (e.g., based on particular user input 524). At least some of such examples 512 can, in some implementations, be generated by machine learning model(s) 514 based on the characteristics and/or features of such wine selections and user profiles. For example, machine learning model(s) 514 can obtain user profile data 516 and wine selection data 518 from one or more databases (e.g., databases of wine sales to users having user profiles), in order to generate examples 512. In some implementations, machine learning model(s) 514 can be trained on actual, historical wine selections paired with actual, historical user profiles of users making such selections, and can be applied to generate examples 512.

In some implementations, it is contemplated that at least some of examples 512 can be generated by one or more actual, working wine professional(s), such as sommelier(s) and/or other(s) with wine certifications or specialties, such as an Advanced Sommelier, an Italian Wine Specialist, an award-winning Wine Director, a Wine Director of an award-winning restaurant, etc. In such implementations, it is contemplated that the wine professional(s) can initially train machine learning model 522 with particular wines or varieties of wines paired with various characteristics, such as what wine goes with particular types of food, descriptors of the wine (e.g., as described further herein with respect to wine definitions 508), preferences associated with the wine, etc.

Customized machine learning model 522 can receive user input 524. In some implementations, user input 524 can include natural language user prompt 528. In some implementations, user prompt 528 can be a verbal or textual description of what kind of wine the user wishes to drink, attributes of wine that the user is looking for, etc. In some implementations, other types of input can also be provided to customized machine learning model 522, such as context data, social graph data, etc., as described further herein. In some implementations, user profile data 526 can include user preference data. The preference data can include annotators relative to particular wines and/or wine varietals, such as styles of wine the user likes, varietals the user likes, attributes of wine the user likes (e.g., dry, sweet, acidic, sparkling, red wine, full bodied, etc.), ratings and/or reviews of wine by the user, whether food and wine combinations have been indicated as being compatible with each other, etc.

Machine learning model 522 can receive system prompt 502, user profile data 516, wine selection data 518, wine list data 520, and user input 524, and apply customizations 506 of system prompt 502, causing customized machine learning model 522 to respond to user input 524 i) based on examples 512, and ii) with wine(s) selected from wine list data 520, corresponding to wines and/or varietals in wine selection data 518 (which, in some cases, can be included in examples 512), based on the wine definitions and user input 524. In some implementations, customized machine learning model 522 can further respond to user input 524 iii) according to an assumed role of the multiple roles defined by customizations 506 according to role definition(s) 510 and user input 524.

For example, in a “brainstormer” role, customized machine learning model 522 can act as a collaborator providing insights, thoughts, feedback, support, and/or information to assist the user in making their own wine selection(s) from the entire wine list or a portion thereof, such as a narrowed predicted set. In an “owner” role, customized machine learning model 522 can select a wine, from the entire wine list list, a portion thereof, or a narrowed predicted set, on behalf on the user (e.g., a wine having a highest match score, as described further herein). In a “sommelier” role, customized machine learning model 522 can present follow-up questions upon generating a narrowed predicted set of wines (or upon receiving the wine list) to further narrow the set and ultimately recommend one or two wines, similar to a sommelier interaction in a restaurant. In assuming different levels of sommelier roles, customized machine learning model 522 can choose from more basic, approachable, and/or mainstream wines (e.g., when assuming an “introductory sommelier” role), or choose from more complex, nuanced, and/or lesser known wines (e.g., when assuming a “master sommelier” role), and at levels therebetween for “certified” and “advanced” sommelier roles. In some implementations, customized machine learning model 522 can determine the level of knowledge to assume for such varying levels of sommeliers based on opensource information, information obtained from the Internet, information obtained from third-party computing systems (e.g., sample educational or study material for sommelier certifications, sample sommelier level descriptions, and/or the like), etc. Customized machine learning model 522 can then generate an indication of recommended wine(s) 530 for user input 524 that can be included in a generated user interface. The generated user interface can be displayed on a display device, which can be the same or a different device on which customized machine learning model 522 is embodied.

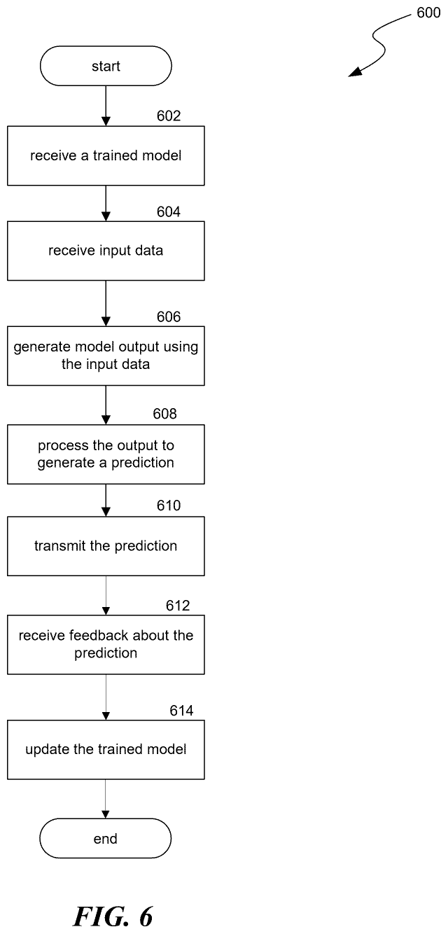

FIG. 6 is a flow diagram illustrating a process 600 used in some implementations for customizing a trained model to perform one or more steps of the processes described herein. For example, process 600 can be used to customize a trained model (e.g., machine learning model 522 of FIG. 5) to make wine recommendation(s) from a wine list. In some implementations, process 600 can be performed as a response to receipt of a machine learning model trained on wine selections mapped to user profiles, and upon a request to generate wine selection(s) from a wine list. In some implementations, process 600 can fully or partially be performed by a user computing device requesting wine recommendation(s). In some implementations, process 600 can be fully or partially performed by a computing system remote from the user computing device, such as a computing system associated with an entity providing wine, a developer computing .system associated with a wine recommendation application, etc. In some implementations, process 600 can be performed by wine recommendation system 164 of FIG. 1, one or more of specialized components 340 of FIG. 3, and/or customized machine learning model 522 of FIG. 5.

At block 602, process 600 can receive a trained model configured to predict a wine selection from a wine list based on a user profile. In some implementations, training data for process 600 can be established by a machine learning model, which, in some cases, can be a large language model. For example, the machine learning model can extract features of such training data to differentiate between the content of natural language words and/or segments in user profiles and their associated wine selections, based on one or more wine definitions (e.g., descriptors). In some implementations, process 600 can train the model by analyzing a large set of natural language user profile data and/or user prompts associated with known wine selections, and automatically learning the inherent features of the natural language relative to the wine selection. Process 600 can map the features of the training data into a classification space identifying candidate wines (e.g., specific wines and/or wine varietals) associated with those features. In some implementations, and as described further herein, process 600 can further customize the trained model according to particular parameters defining how the model selects results.

At block 604, process 600 can receive input data, such as user profile data associated with a user. As described above with respect to block 404 of FIG. 4, process 600 can obtain the user profile data by, e.g., querying the user for data relevant to user preferences. In some implementations, the user profile can include identifying or demographic information associated with the user (e.g., age, gender, nationality, ethnicity, height, weight, education level, profession, etc.), a level of sophistication of the user relative to wine, content previously or often accessed by the user, previous purchases and/or consumptions of particular wines, communications and/or queries by the user, and/or any other user data that may be relevant to what the user likes, what the user purchases, and/or the user's comprehension or skill level relative to wine. The input data can further include wine list data, such as a textual listing of wines available for purchase and/or consumption at a location, which can be obtained from a website, extracted from an image of the wine list, etc. In some implementations, the input data can further include a natural language user prompt (e.g., “I'm in the mood for a dry red wine tonight.”).

In some implementations, process 600 can also receive contextual factors surrounding the input data, such as a food currently being consumed or being considered for consumption. In some implementations, food data can be provided by the user in natural language via a keyboard, based on an image of a menu (e.g., obtained from the Internet or captured by a camera of a mobile device), by analyzing an image of food captured by the user via a mobile device, etc. Other contextual factors can include, for example, location (e.g., in a particular city or state), type of establishment (e.g., restaurant or home), type of restaurant (e.g., fine dining versus fast casual), environmental conditions (e.g., outdoors, indoors, rainy, cold, hot, etc.), and/or any other contextual data that may be relevant to what the user is doing, trying to do, user preferences, wine preferences, etc.

At block 606, process 600 can generate an output using the input data, the trained model, and any contextual factors. In some implementations, based on the input data, process 600 can extract relevant features from the input data, and map the features as data points on an output vector in the classification space created using the training data.

At block 608, process 600 can process the output to generate predicted wine(s), from the wine list data, for the user profile. In some implementations, process 600 can generate a match score between the input data (i.e., the mapped features of the user profile data) and the features of candidate wines in the classification space by calculating a distance between the output and the candidate wines. The match score can be any numerical or textual value or indicator, such as a statistic or percentage. Process 600 can identify the predicted wine based on, for example, the candidate wine having the highest match score to the output. In some implementations, process 600 can identify multiple predicted wines having match scores above a threshold, e.g., 70%, and in some implementations, can rank the predicted wines from the highest match score to the lowest match score. At block 610, process 600 can output the predicted wine. In some implementations, process 600 can output the predicted wine to a display, such as a user computing device or computing system associated with an entity providing wine.

At block 612, process 600 can receive feedback about the predicted wine. In some implementations, the feedback can be explicit, e.g., the user confirms, via the user computing device, that the predicted wine was liked or disliked by the user, that the predicted wine was purchased or not purchased by the user, that a sommelier agreed with the predicted wine selection, that the wine paired well with particular food, etc., when the predicted wine is presented to the user via the user computing device. If the feedback is negative, the feedback can include a different selected wine, which can be selected by the user or a sommelier in some implementations. Such explicit or implicit feedback (e.g., the user fails to correct or ask the system or a sommelier for a different predicted wine) can be indicative of whether the predicted wine was correct.

At block 614, process 600 can update the trained model. For example, process 600 can use the feedback data to identify whether the predicted wine was correct or incorrect (and if incorrect, what the correct wine was, if available), and use that information as a comparison factor to update the model and/or the classification space. In some implementations, process 600 can weigh the current training data more heavily than the initial or past training data, as the later training data can be considered more relevant and/or accurate. Although illustrated as a single process 600 in FIG. 6, it is contemplated that process 600 can be performed multiple times and/or repeatedly, either consecutively or concurrently, as additional input data is obtained.

Some implementations of the wine recommendation system can include a machine learning component, such as a neural network, that is trained using a variety of data, including user profile data (which can include natural language descriptors in some cases), wine descriptors (which can include natural language in some cases), sommelier selections, contextual factors, and whether a user (or other user(s)) identified a predicted wine as correct or incorrect. Some implementations can feed new input data including a user profile, a wine list, and contextual factors into the trained machine learning component, and based on the output, can generate a predicted wine (or multiple predicted wines). Some implementations provide this predicted wine to a user via a computing device or computing system, and can receive feedback about the predicted wine to further enhance the trained model, in order to predict or further refine wine selection based on one or more user prompts, additional and/or updated wine data, availability data, etc.

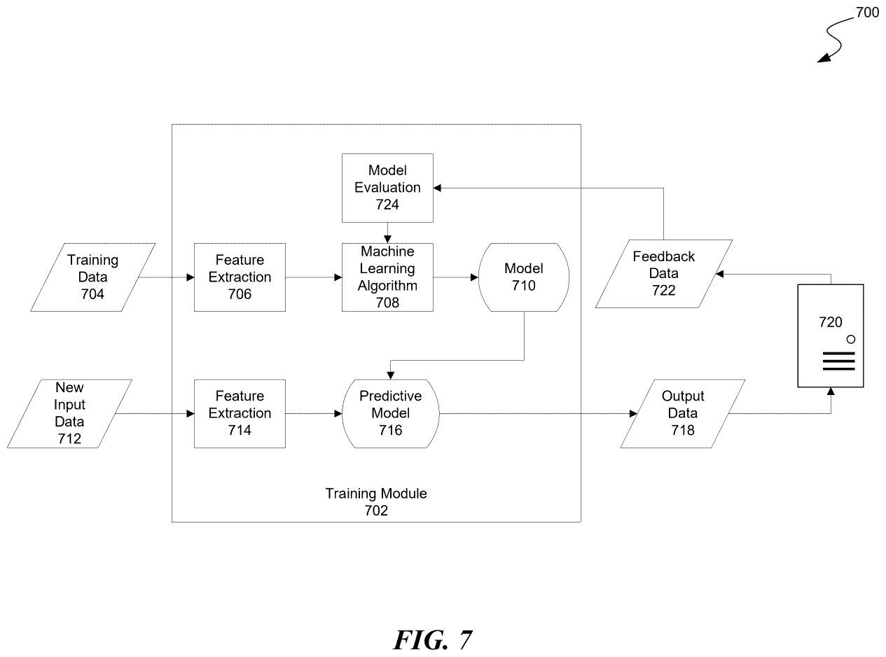

FIG. 7 is a block diagram illustrating an overview of a machine learning system 700 that can be applied and customized to perform one or more steps of the processes described herein according to some implementations of the present technology. For example, system 700 can be used to apply and update and/or modify parameters of a trained model (e.g., machine learning model 522 of FIG. 5) to predict a wine selection for a user, based on a mapping of wine selections to user profiles.

In some implementations, system 700 can be included in a user computing device requesting a wine recommendation. In some implementations, system 700 can be included in a computing system remote from a user computing device, such as a computing system associated with an entity providing a wine recommendation application, an entity providing wine (e.g., a restaurant, a wine store, etc.), and/or the like. In some implementations, system 700 can be included in wine recommendation system 164 of FIG. 1. In some implementations, system 700 can perform similar functions as one or more of specialized components 340 of FIG. 3, and/or customized machine learning model 522 of FIG. 5.

In a training phase, system 700 can feed raw training data 704 (e.g., historical or synthetic user profiles, historical or synthetic wine selections, wine definitions, etc.) into feature extraction 706 of training module 702 to select useful features (e.g., words, phrases, sentences, characteristics, etc.) from all available features. As described further herein, contextual factors that can also be considered can include a time of day, a time of year, weather, location, type of establishment (e.g., restaurant, wine store, residential, etc.), type of event (e.g., brunch, lunch, dinner, party, wedding, etc.), and/or any other contextual data that may be relevant to what the respective user was doing and/or who the user is, what the user likes, user preferences, etc. The user profile data can include user demographics, previously obtained wines by the user, historical user actions or events, historical user queries, and/or the like.

System 700 can feed the extracted features to machine learning algorithm 708. Machine learning algorithm 708 can identify a model 710 that maps the input data and any available user prompt data and contextual factors to predict wine selections for user profiles, and uses past feedback to identify whether the predictions were correct. In some implementations, model 710 can be a neural network. System 700 can repeat the training phase until a suitable accuracy level is reached, e.g., as identified by applying a loss function, such as when a sufficient amount of training data 704 has been processed and predictions made by model 710 do not deviate too far from actual results. As appreciated by one skilled in the art, if model 710 is a deep learning model, a large amount of training data (e.g., tens or hundreds of thousands of sets of training data) may be needed to make accurate predictions.

In a predicting phase, system 700 can feed new input data 712 (e.g., a new user profile, a wine list, a new user query, etc.) into feature extraction 714 of training module 702 to select useful features. System 700 can apply a predictive model 716 to the extracted features based on the trained model 710 to generate output data 718 (e.g., a predicted wine for the user). In some implementations, system 700 can provide output data 718 to computing system 720, such as the user computing device or a computing system of another user, such as a representative of an entity providing wine, a third-party computing system providing data about wine, a sommelier, etc. Computing system 720 can, for example, display the predicted wine. The user of computing system 720 can provide feedback data 722 to training module 702, such as explicit feedback regarding whether the user liked the predicted wine (e.g., the user indicates that the predicted wine was enjoyable or not enjoyable), or implicit feedback (e.g., the user fails to correct the predicted wine and/or fails to request an alternative wine recommendation). In some implementations, trained model 710 can predict multiple possible wines responsive to a user profile and/or query (e.g., such as when multiple wines have a same match score or match score above a threshold). In some implementations, the user of computing system 720 can select a wine of the possible wines, which, in some cases, can be ranked based on match score. Such a selection can then be provided to the user device providing new input data 712, and can further be used as feedback data 722 to update model 710 for further iterations, as described herein.

System 700 can input any feedback data 722 into model evaluation 724 to restart the training phase. Model evaluation 724 can evaluate predictive model 716 with metrics, for example. The metrics can include accuracy, precision, F1 score, Mean Squared Error, etc. System 700 can feed these metrics back into machine learning algorithm 708 to refine and update model 710, if necessary, and the predicting phase can be repeated with greater accuracy.

FIG. 8A is a conceptual diagram illustrating an exemplary field-of-view 800A, of a camera of a mobile device 810, including a wine list 804 that can be input into a customized machine learning model to automatically recommend wine to a user 806. In FIG. 8A, user 806 can be dining at restaurant 802 and can request or otherwise obtain wine list 804. User 806 can, using the camera of mobile device 810, capture field-of-view 800A, including an image of wine list 804. In this example, wine list 804 can include types of wine (e.g., sparkling, white, red), vintages (e.g., NV, 2013, 2022, etc.), producers (e.g., ABC, DEF, GHI, etc.), and varietals (e.g., Champagne, Chablis, Burgundy, etc.). Although shown as including specific kinds of wine data, it is contemplated that wine list 804 can include any less, additional, or alternative wine data described herein.

Upon capturing this image, the wine recommendation system can perform techniques such as text recognition, object detection, and/or object recognition to digitally parse wine list 804. This process can extract the names, vintages, and other details of the available wines. The extracted information, in full or in part, can become wine list data that can be processed by the customized machine learning model described herein to generate personalized wine recommendations, ensuring that the recommendations are limited to the specific wines available to the user at that moment. In some examples, the background elements within field-of-view 800A, such as the restaurant, table, and decor, can also serve as environmental or context data, further informing the wine recommendation system about the user's current setting and ambiance.

FIG. 8B is a conceptual diagram illustrating an example field-of-view 800B, of a camera of a mobile device 810, including an image of food 808 that can be captured and input into a customized machine learning model to automatically recommend wine to a user 806. The wine recommendation system can perform image analysis and object recognition on the captured image of food 808 to identify the contents of the dish. For example, the wine recommendation system could identify the meal as roasted chicken with vegetables. Alternatively or additionally, the user can audibly announce what type of food 808 is being or will be consumed, which can be detected by a microphone on or proximate to mobile device 810, and processed using speech recognition techniques.

The information derived from this analysis can constitute contextual data (e.g., food data) that can be fed as an input to the customized machine learning model described herein. Thus, the customized machine learning model can whittle down what user 806 should drink based on what they're eating. By identifying the characteristics of food 808, the customized machine learning model can significantly refine its selection process. It can use this food data, in conjunction with the user's profile and the previously captured wine list (e.g., wine list 804), to make a highly specific and appropriate pairing recommendation. For instance, by identifying the dish as roasted chicken, the customized machine learning model could prioritize wines from the available list that pair well with poultry, such as a crisp Chablis or a versatile Sancerre, over a heavy Cabernet Sauvignon that might overpower the dish. In some implementations, this step demonstrates how the wine recommendation system can use real-time, visual context to emulate the nuanced decision-making of a human sommelier, who would invariably ask, “What will you be eating?” before making a final wine recommendation. It elevates the wine recommendation system from a simple preference matcher to a true, context-aware pairing expert.

FIG. 8C is a conceptual diagram illustrating an example field-of-view 800C, of a user 806, including user interface (UI) 812 presented on a mobile device 810 with recommended wines predicted by a customized machine learning model. UI 812 can be generated after the customized machine learning model predicts the wines based on, for example, wine list 804 and food 808, as well as a user profile. For example, prior to generating the recommended wines, UI 812 can prompt the user to answer a series of questions narrowing their preferences, can obtain user demographic data from stored user data or import it from social media, etc.

The recommended wines on UI 812 are not arbitrary; it is output generated by the customized machine learning model, which has been translated into a clear, user-friendly format. On UI 812, the numbered ranking indicates that the wines are presented in a particular order defined by a match score calculated by the customized machine learning model, with the “2022 GHI Chablis” being the model's top recommendation based on the user's profile and the context of their meal, from wine list 804.

In some examples, UI 812 can further assist in implementing the customized machine learning model's feedback loop. From UI 812, user 806 can make a selection of a wine that they will order, which can then be used for updating the customized machine learning model. For example, if the user taps on and confirms the “2022 GHI Chablis,” that selection can be added to their user profile, further personalizing the model for future recommendations. In some implementations, UI 812 can also provide an option for the user to provide a rating for the wine after tasting it. In essence, FIG. 8C demonstrates how the wine recommendation system described herein delivers expert, personalized, and actionable recommendations to the user, effectively acting as a digital sommelier by presenting a short, curated list of the best options from a potentially long and intimidating wine list.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for automatically recommending wine to a user, the method comprising:
providing a system prompt defining customizations for a machine learning model, the customizations including A) a set of exemplary wine selections, each exemplary wine selection being correlated with one or more exemplary user profiles, B) wine definitions for multiple wine varietals, and C) role definitions defining multiple roles that the machine learning model can assume and guidelines for the machine learning model to select a role for various user inputs;
generating a profile for the user, the profile including one or more of preferences of the user, user demographic data, a user wine knowledge level, historical wine purchases by the user, or any combination thereof;
obtaining wine list data indicative of multiple wines, the wine list data being obtained from one or more images captured by a camera of a mobile device of the user and/or being obtained from a computing system associated with an entity providing wine;
customizing the machine learning model and applying the customized machine learning model to input data including i) the profile of the user and ii) the wine list data by:
applying the customizations, from the system prompt, to the machine learning model causing the machine learning model to respond to the input data x) based on the set of exemplary wine selections, y) with one or more wine varietals selected based on the wine definitions and the input data, and z) with the machine learning model assuming one of the multiple roles according to the role definitions and the input data; and
selecting, by the customized machine learning model, one or more wines of the multiple wines indicated by the wine list data based on the input data;
generating a user interface including an indication of the selected one or more wines; and
causing display of the generated user interface.

2. The method of claim 1, further comprising:
receiving, via the user interface, a user selection of a wine, of the selected one or more wines;
obtaining, from a remote computing system, additional data associated with the wine indicated by the user selection, wherein the additional data includes one or more of wine description data, tasting note data, vineyard data, pricing data, availability data, volume data, varietal data, aging data, skin contact data, harvest data, release data, winemaker data, producer data, or any combination thereof; and
updating the user interface with the additional data associated with the wine indicated by the user selection.

3. The method of claim 1,
wherein the generating the user interface includes:
generating structured output data representative of the selected one or more wines; and
translating the structured output data into the generated user interface; and
wherein the mobile device renders the generated user interface.

4. The method of claim 3, wherein the role definitions define how the structured output data is translated into the generated user interface.

5. The method of claim 3, wherein the translating the translating the structured output data into the generated user interface is based on hardware and/or software constraints of the mobile device.

6. The method of claim 1, further comprising:
obtaining, from a remote computing system, additional data associated with the selected one or more wines, wherein the additional data includes one or more of wine description data, tasting note data, vineyard data, pricing data, availability data, volume data, varietal data, aging data, skin contact data, harvest data, release data, winemaker data, producer data, or any combination thereof,
wherein the generated user interface further includes at least a portion of the additional data associated with the selected one or more wines.

7. The method of claim 1, wherein the guidelines, for the machine learning model to select the role, define types of user input mapped to roles, the types of user input including one or more of x) professional experience level with wine, y) educational experience level with wine, or z) personal experience level with wine.

8. The method of claim 1, wherein the input data further includes context data captured by the camera of the mobile device and/or one or more sensors of the mobile device.

9. The method of claim 8, wherein the context data includes menu data, food data, environmental data, or any combination thereof.

10. The method of claim 1, wherein the entity providing the wine is identified based on an obtained location of the mobile device of the user.

11. The method of claim 1, further comprising:
obtaining feedback regarding at least one of the selected one or more wines; and
updating the machine learning model based on the feedback.

12. The method of claim 11, wherein the feedback includes a selection, by the user, of a wine of the selected one or more wines.

13. The method of claim 11, wherein the feedback includes a rating, by the user, of a wine of the selected one or more wines.

14. The method of claim 1, wherein the profile for the user includes past selections of wine by the user.

15. The method of claim 1, further comprising:
obtaining a selection, by the user, of a wine of the predicted one or more recommended wines; and
adding the selected wine to the user profile.

16. The method of claim 1, wherein the one or more recommended wines are further selected based on a promotion and/or an association with a wine producer.

17. A computer-readable storage medium storing instructions, for automatically recommending wine to a user, the instructions, when executed by a computing system, cause the computing system to:
provide a system prompt defining customizations for a machine learning model, the customizations including A) a set of exemplary wine selections, each exemplary wine selection being correlated with one or more exemplary user profiles, and B) wine definitions for multiple wine varietals, and C) a role definition defining a sommelier role that the machine learning model can assume;
generate or obtain a profile for the user, the profile including one or more of preferences of the user, user data, or both;
obtain wine list data indicative of multiple available wines;
customize the machine learning model and apply the customized machine learning model to input data including i) the profile of the user and ii) the wine list data by:
applying the customizations, from the system prompt, to the machine learning model causing the machine learning model to respond to the input data x) based on the set of exemplary wine selections, y) with one or more wine varietals selected based on the wine definitions and the input data, and z) with the machine learning model assuming the sommelier role according to the role definition; and
select, by the customized machine learning model, one or more wines of the multiple wines indicated by the wine list data based on the input data; and
output an indication of the selected one or more wines.

18. The computer-readable storage medium of claim 17, wherein the wine is data is obtained from one or more images captured by a camera of a mobile device of the user.

19. A computing system for automatically recommending wine to a user, the computing system comprising:
one or more processors; and
one or more memories storing instructions that, when executed by the one or more processors, cause the computing system to:
provide a system prompt defining customizations for a machine learning model, the customizations including A) a set of exemplary wine selections, each exemplary wine selection being correlated with one or more exemplary user profiles, and B) wine definitions for multiple wine varietals, and C) a role definition defining a sommelier role that the machine learning model can assume;
generate or obtain a profile for the user, the profile including one or more of preferences of the user, user data, or both;
obtain wine list data indicative of multiple available wines;
customize the machine learning model and apply the customized machine learning model to input data including i) the profile of the user and ii) the wine list data by:
applying the customizations, from the system prompt, to the machine learning model causing the machine learning model to respond to the input data x) based on the set of exemplary wine selections, y) with one or more wine varietals selected based on the wine definitions and the input data, and z) with the machine learning model assuming the sommelier role according to the role definition; and
select, by the customized machine learning model, one or more wines of the multiple wines indicated by the wine list data based on the input data; and
output an indication of the selected one or more wines.

20. The computing system of claim 19, wherein the indication of the predicted one or more wines is output to a computing system associated with an entity providing wine.
